(19) United States
(12) Patent Application Publication
(10) Pub. No.: US 2024/0258603 A1
(43) Pub. Date: Aug. 1, 2024

(54) MECHANICALLY COUPLED, MULTILAYER BATTERY PACK INSULATOR

(71) Applicant: FEDERAL-MOGUL POWERTRAIN LLC, Northville, MI (US)

(72) Inventor: William T. Rubel, JR., Spring Lake, NJ (US)

(21) Appl. No.: 18/423,929

(22) Filed: Jan. 26, 2024

Related U.S. Application Data
(60) Provisional application No. 63/441,837, filed on Jan. 29, 2023.

(51) Int. Cl. H01M 10/653; B60L 50/64; C09J 7/29; C09J 7/38; H01M 50/209; H01M 50/383

(52) U.S. Cl. CPC H01M 10/653; B60L 50/64; C09J 7/29; C09J 7/38; H01M 50/209; H01M 50/383; C09J 2203/33; C09J 2203/354; C09J 2301/302; C09J 2400/123; C09J 2483/006; H01M 2220/20

(57) ABSTRACT

A multilayer thermal insulator for an electric vehicle battery pack having a flexible multilayer wall multilayer wall including, a flame resistant outer laminate, a ceramic-based layer, and a pressure-sensitive adhesive layer. The ceramic-based layer is sandwiched between the flame resistant outer laminate and the pressure-sensitive adhesive layer. A filament fixes the flame resistant outer laminate, the ceramic-based layer, and the pressure-sensitive adhesive layer to one another.

### CROSS-REFERENCE TO RELATED APPLICATION

This application claims the benefit of U.S. Provisional Application Ser. No. 63/441,837, filed Jan. 29, 2023, which is incorporated herein by reference in its entirety.

### BACKGROUND OF THE INVENTION

### 1. Technical Field

This invention relates generally to thermal insulators, and more particularly to multilayer thermal insulators for inhibiting flame propagation between and from cells of a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against extreme heat and/or flame propagation, such as may be experienced in a thermal runaway condition of one or more cells of the electric vehicle battery pack. As shown in FIGS. 2A-2C, a battery pack 12 and housing 14 thereof are shown having a fiberglass insulator between and about cells 16 of the battery pack 12. The fiberglass insulator can result in a thermal runaway condition originating in any one of the cells 16 of the battery pack 12, such that heat and flame propagates from a single cell 16 (FIG. 2A) to multiple cells (FIG. 2C), in less than 5 minutes at a temperature of 1000° C.

It is desired to provide a thermal insulation that inhibits the propagation of flame between cells of a battery pack for 5 minutes or more at a temperature of 1000° C.-1400° C.

### SUMMARY OF THE INVENTION

It is an object of the present disclosure to provide a multilayer material for use with an electric vehicle battery pack that addresses at least the desire to inhibit the propagation of flame from the battery pack for 5 minutes or more at a temperature of 1000-1400° C.

It is a further object of the present disclosure to provide a multilayer material for use with an electric vehicle battery pack that minimizes the amount of flame fuel present within the multilayer material, thereby inhibiting the propagation of flame between cells of the battery pack.

It is a further object of the present disclosure to provide a multilayer material for use with an electric vehicle battery pack that is flexible, lightweight, has a thin, low profile to minimize the amount of space occupied by the thermal insulator, and is economical in manufacture and in use.

One aspect of the invention provides a multilayer thermal insulator for an electric vehicle battery pack having a flexible multilayer wall including, a flame resistant outer laminate, a ceramic-based layer, and a pressure-sensitive adhesive layer. The ceramic-based layer is sandwiched between the flame resistant outer laminate and the pressure-sensitive adhesive layer, and at least one filament fixes the flame resistant outer laminate, the ceramic-based layer, and the pressure-sensitive adhesive layer to one another.

In accordance with another aspect of the invention, the pressure-sensitive adhesive layer is a single-sided pressure-sensitive adhesive layer including a film layer and an adhesive material on only one side of the film layer, wherein the film layer faces the ceramic-based layer and the adhesive material is spaced from and faces away from the ceramic-based layer.

In accordance with another aspect of the invention, the film layer is not bonded to the ceramic-based layer with an adhesive material, such that an air layer is provided between the film layer and the ceramic-based layer to allow relative movement between the film layer and the ceramic-based layer and enhance thermal resistance and reduce flame propagation between the film layer and the ceramic-based layer.

In accordance with another aspect of the invention, the pressure-sensitive adhesive layer includes a release layer that is releasably bonded to the adhesive material for selective removal from the adhesive material to expose the adhesive material for adhesion to a surface of the electric vehicle battery pack.

In accordance with another aspect of the invention, the release layer has an edge region and an interior region, the filament passing through the edge region such that the edge region remains bonded to the adhesive material after selective removal of the interior region from the adhesive material.

In accordance with another aspect of the invention, the edge region through which the filament passes includes opposite edge regions spaced from one another by the interior region.

In accordance with another aspect of the invention, the release layer includes a weakened line region connecting the interior region to the edge region, the weakened line region facilitating separation of the interior region from the edge region while selectively removing the release layer from the adhesive material.

In accordance with another aspect of the invention, the flame resistant outer laminate and the ceramic-based layer are not bonded to one another with an adhesive material, thereby reducing the amount of flame fuel present in the multilayer thermal insulator, and thus, reducing the potential of flame propagation through the multilayer thermal insulator.

In accordance with another aspect of the invention, the adhesive material of the pressure-sensitive adhesive layer is the only adhesive material in the multilayer wall, thereby reducing potential fuel for flame propagation, reducing cost and thickness, and reducing potential for a stitch needle to become gummed up while stitching the multiple layers to one another.

In accordance with another aspect of the invention, the flame resistant outer laminate includes a polymeric film.

In accordance with another aspect of the invention, the ceramic-based layer is a ceramic paper.

In accordance with another aspect of the invention, the flexible multilayer wall has a maximum thickness of 2.0 mm.

In accordance with another aspect of the invention, an electric vehicle battery pack is provided. The electric vehicle battery pack includes a housing bounding a plurality of cells. Further, a multilayer wall is disposed between and/or about the plurality of cells. The multilayer wall includes, a flame resistant outer laminate; a ceramic-based layer; a pressure-sensitive adhesive layer, wherein the ceramic-based layer is sandwiched between the flame resistant outer laminate and the pressure-sensitive adhesive layer; and a filament fixing the flame resistant outer laminate, the ceramic layer, and the pressure-sensitive adhesive layer to one another.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a multilayer thermal insulator constructed in accordance with an aspect of the invention;

FIGS. 2A-2C illustrate a schematic representation of an electric vehicle battery pack in accordance with prior art, not having a multilayer thermal insulator in accordance with the disclosure, undergoing a thermal runaway condition with a flame propagating from a location of flame initiation (FIG. 2A) throughout a plurality of cells of the battery pack (FIG. 2C);

FIGS. 3A-3C are views similar to FIGS. 2A-2C, with the electric vehicle battery pack including the multilayer thermal insulator constructed in accordance with an aspect of the disclosure, with the multilayer thermal insulator shown suppressing and inhibiting flame propagating from a location of a thermal runaway condition within a cell (FIG. 3A) throughout the plurality of cells of the battery pack (FIG. 3C);

FIG. 4 is a schematic perspective side view of a multilayer thermal insulator in accordance with a non-limiting embodiment of the disclosure;

FIG. 5 is a schematic perspective side view of a fire-resistant outer laminate layer of the multilayer thermal insulator in accordance with a non-limiting embodiment of the disclosure;

FIG. 6 is a schematic perspective side view of a pressure-sensitive adhesive layer of the multilayer thermal insulator in accordance with a non-limiting embodiment of the disclosure;

FIGS. 7A and 7B illustrate respective top and bottom perspective views of the multilayer thermal insulator in accordance with a non-limiting embodiment of the disclosure;

FIG. 8 is a view similar to FIG. 7B showing a central interior region of a release layer being removed from an underlying pressure-sensitive adhesive to allow the multilayer thermal insulator to be bonded to a desired surface;

FIG. 9A illustrates the multilayer thermal insulator prior to removing the central interior region of the release layer along with a housing member for bundling individual cells of the electric vehicle battery pack; and

FIGS. 9B and 9C illustrate opposite sides of the multilayer thermal insulator after removing the interior region of a release layer and bonding the multilayer thermal insulator to the housing member.

### DETAILED DESCRIPTION OF PREFERRED EMBODIMENTS

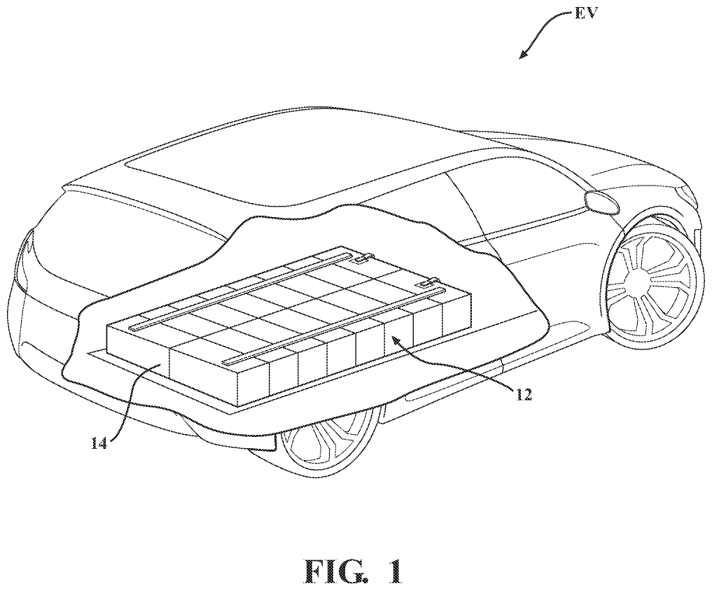

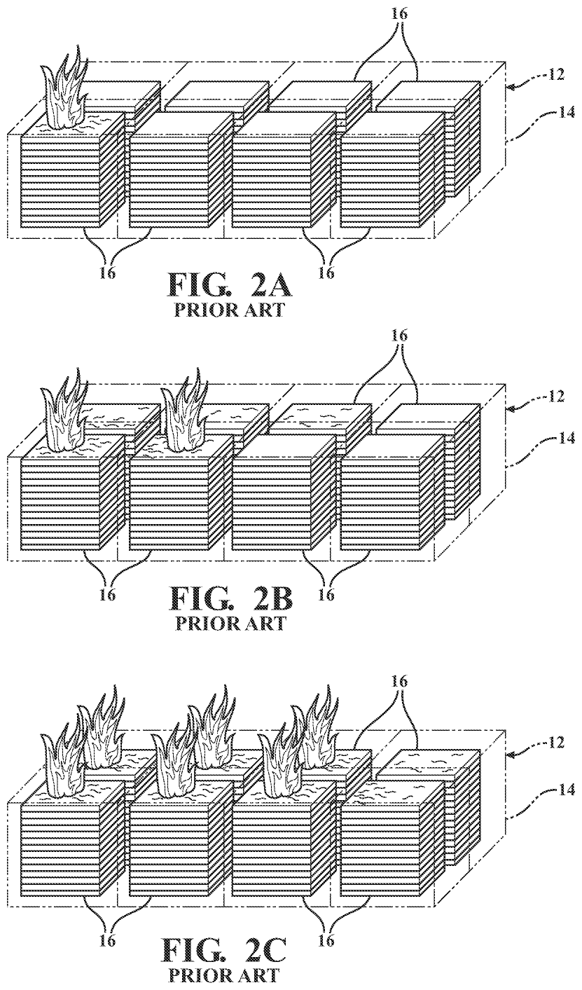

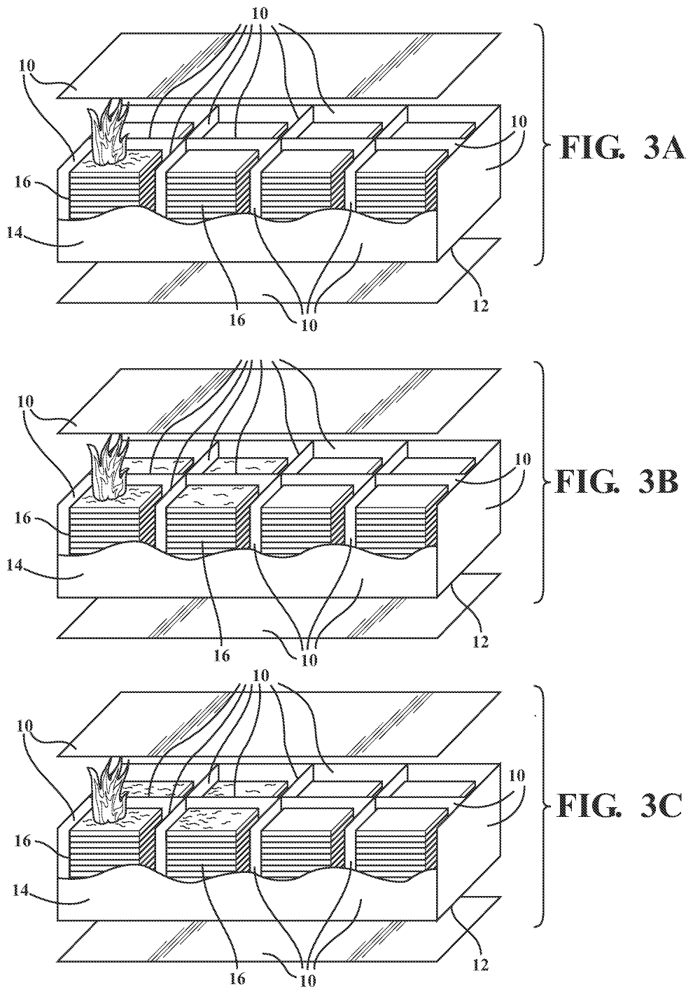

Referring in more detail to the drawings, FIG. 1 illustrates a motor vehicle, shown as an electrically powered motor vehicle, also referred to as electric vehicle EV, having a battery pack 12, such as a lithium-ion battery pack, by way of example and without limitation, configured with a multilayer thermal insulator 10 in accordance with an aspect of the invention. The electric vehicle battery pack 12 includes a housing member, also referred to as casing or housing 14, bounding a plurality of cells 16, and including bus-bars electrically interconnecting cells with one another, high voltage electrical connectors, cell interfaces, low voltage signal wires, high voltage cables and a cooling system having cooling tubes through which coolant can flow, as is generally known in electric vehicle battery packs. During normal use, and including in non-normal situations, such as in a vehicle crash condition or some other condition causing an impact force to battery pack 12, in contrast to a battery pack 12 not having a multilayer thermal insulator 10 as disclosed herein, whereat flame propagation can result, as shown in FIGS. 2A-2C, a thermal runaway condition originating in any one of the cells 16 of a battery pack 12, with the multilayer thermal insulator 10 being disposed between and/or about the cells 16, is controlled and contained via the multilayer thermal insulator 10, as illustrated in FIGS. 3A-3C, such that flame propagation is prevented for at least 5 minutes at an internal cell temperature ranging between 1000-1400° C., and an outer surface temperature of the battery housing 14, also referred to as case, is maintained to be less than 500° C. for 5 minutes.

As shown schematically in FIGS. 3A-3C, the multilayer thermal insulator(s) 10, which can be arranged to thermally isolate the cells 16 from one another, as well as to shield and protect surfaces of the battery pack housing 14, the aforementioned bus-bars, high voltage electrical connectors, cell interfaces, low voltage signal wires, high voltage cables and cooling tubes against extreme temperature thermal runaway conditions and contamination, such as from fluid or debris, as well as from impact forces, such as may be experienced in a crash condition, includes a relatively thin, such as about 2.0 mm, and flexible multilayer wall, also referred to as wall 18. The wall 18, being thin and flexible, can be wrapped into a hollow tubular sleeve configuration about bus bars, wires, tubes, connectors and the like, and can also be used in sheet form, such as a flat planar sheet, to provide a protective outer barrier about an outer periphery of the cells 16, as well as to provide a protective barrier between adjacent cells 16 to effectively thermally isolate each cell 16 from an adjacent cell 16.

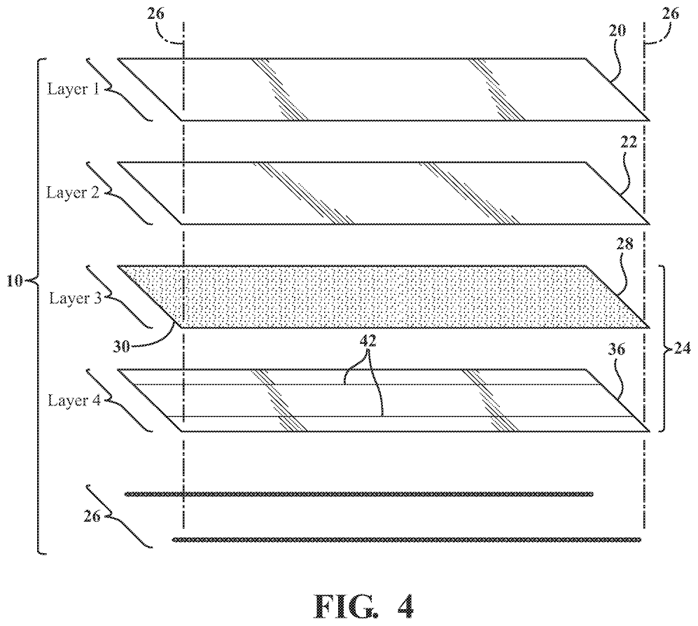

The wall 18, in the non-limiting embodiment illustrated, as best shown in FIG. 4, is shown including a flame resistant outer laminate 20, having a thickness of about 0.15-0.3 mm, a ceramic-based layer 22, such as a ceramic nonwoven material, also referred to as ceramic paper, having a thickness of about 1.6-1.8 mm, and a pressure-sensitive adhesive layer 24, having a thickness of about 0.2-0.4 mm, and a filament 26, such as a fiberglass, nomex, aramid filament, and coated filament, such as any of the aforementioned filaments coated with polytetrafluoroethylene (PTFE), by way of example and without limitation, mechanically coupling and fixing the flame resistant outer laminate 20, the ceramic-based layer 22, and the pressure-sensitive adhesive layer 24 to one another. The ceramic-based layer 22 is captured in sandwiched relation between the flame resistant outer laminate 20 and the pressure-sensitive adhesive layer 24. As such, the flame resistant outer laminate 20, the ceramic-based layer 22, and the pressure-sensitive adhesive layer 24 are not bonded to one another with an adhesive material. Accordingly, an air layer is formed between the outer laminate 20 and the ceramic-based layer 22 to allow relative movement therebetween, as well as between the ceramic-based layer 22 and the pressure-sensitive adhesive layer 24 to allow relative movement therebetween, wherein the air layers further reduce flame propagation between the flame resistant outer laminate 20, the ceramic-based layer 22, and the pressure-sensitive adhesive layer 24.

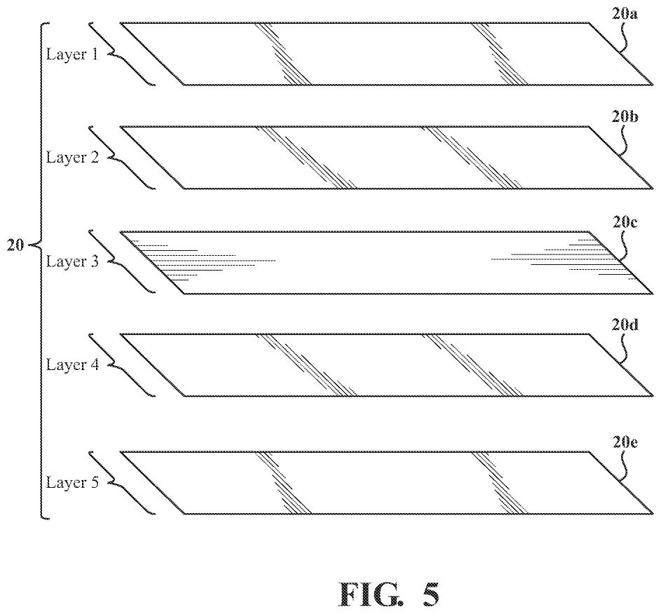

The flame resistant outer laminate 20, as best shown in FIG. 5, has an outermost polymeric layer 20a, such as polyetheretherketone (PEEK), by way of example and without limitation, a flame resistant coating 20b bonded to the outermost polymeric layer 20a, such as a mica-based and/or silica-based coating, and in one non-limiting embodiment, a silicone mica coating 20b, a textile fire-resistant layer, such as a woven plain weave fire-resistant layer 20c, such as can be woven with one or more of fiberglass, silica, nomex, and basalt, by way of example and without limitation, a silicone adhesive 20d, and in innermost polymeric layer 20e bonded to the silicone adhesive 20d, such as (PEEK) 20d, by way of example and without limitation. The textile fire-resistant layer 20c is sandwiched between and bonded to the flame resistant coating 20b and the silicone adhesive 20d.

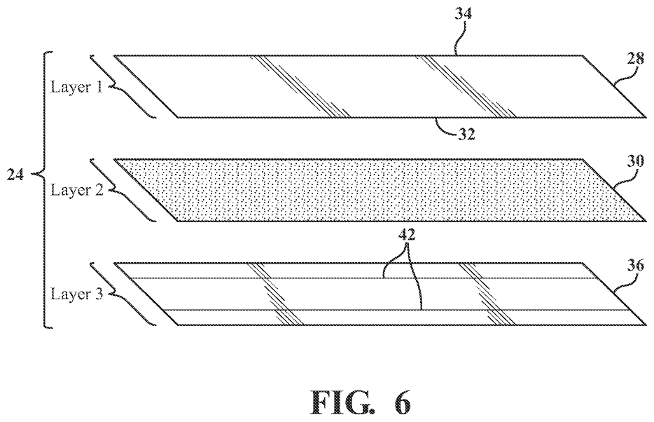

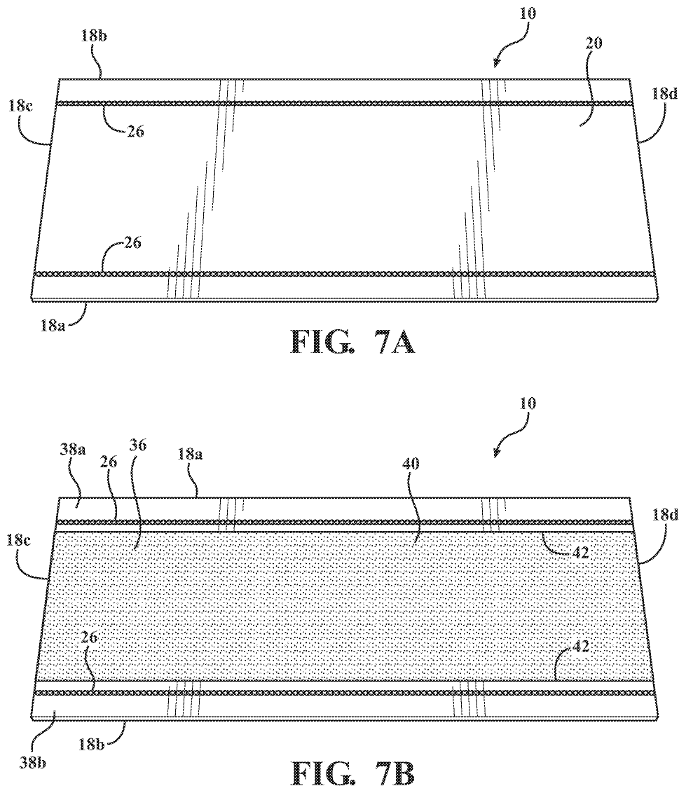

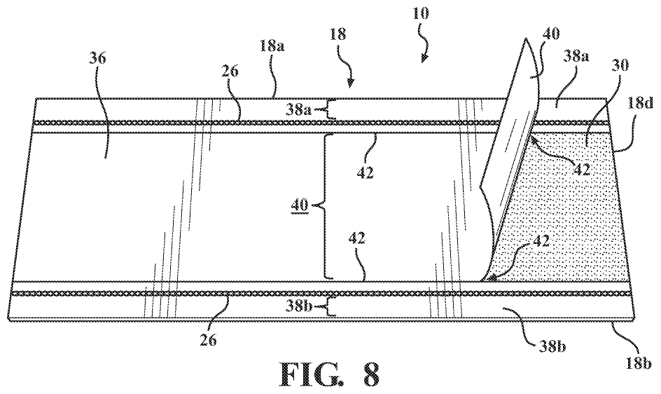

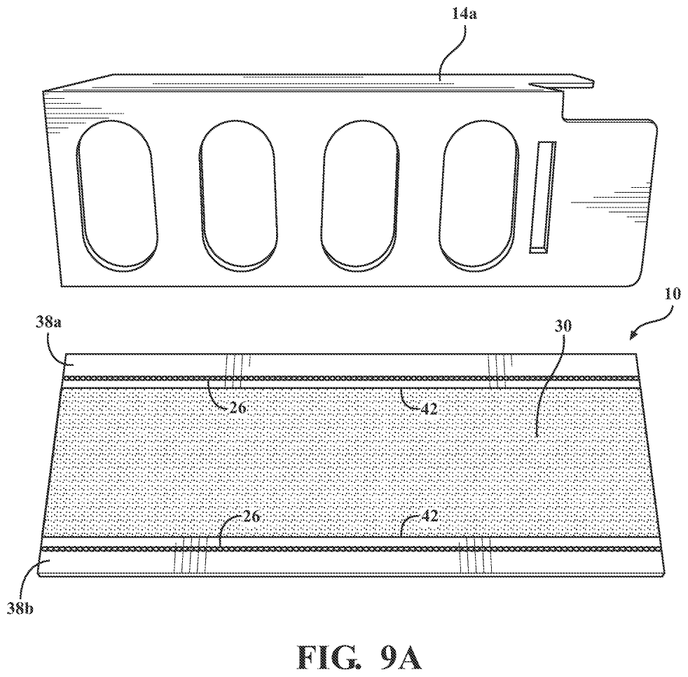

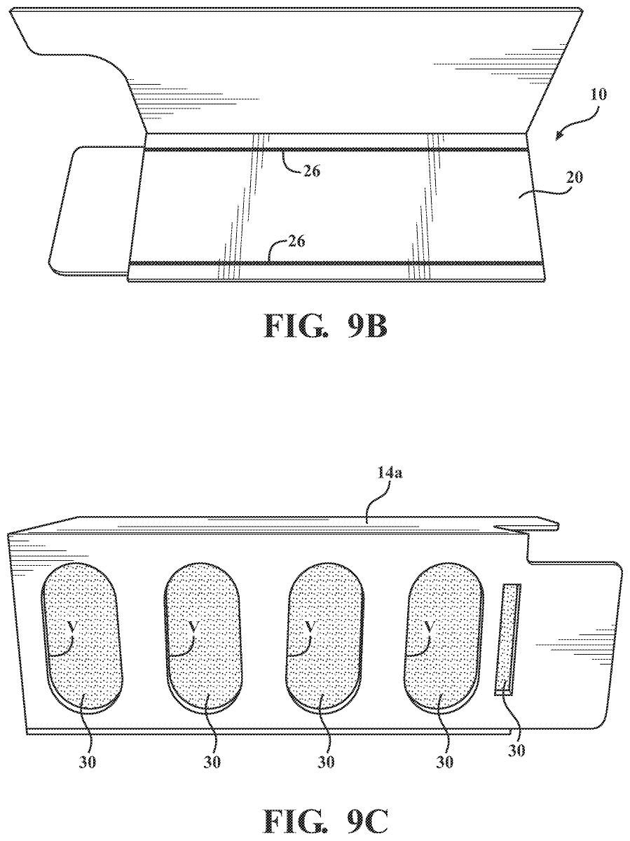

As best shown in FIG. 6, pressure-sensitive adhesive layer 24 is a single-sided pressure-sensitive adhesive layer including a film/scrim layer 28, such as a scrim layer of polyethylene terephthalate (PET), an adhesive material 30. The adhesive material 30 is present on only one side 32 of the scrim layer 28, such that an opposite side 34 of the film layer 28 is free of adhesive material. The adhesive-free side 34 of the scrim layer 28 faces and abuts the ceramic-based layer 22 and the side 32 with the adhesive material 30 is spaced from and faces away from the ceramic-based layer 22. The pressure-sensitive adhesive layer 24 further includes a release layer 36, also referred to as release film, such as a polyethylene terephthalate (PET) film, by way of example and without limitation, which is releasably bonded to the adhesive material 30 for selective removal from the adhesive material 30 to expose the adhesive material 30 for adhesion to a surface of the electric vehicle battery pack 12 (FIGS. 3A-3C and 9A-9C), such as to a surface between adjacent cells 16 and/or to an outer surface bounding the cells 16 and/or to any other surface of the housing 14. As shown in FIG. 4B, the release layer 36 has a pair of outer peripheral edge regions 38a, 38b and an interior region 40 bounded by the edge regions 38a, 38b. The filament 26 passes through (pierces) the entirety of the thermal insulator 10 (FIGS. 7A and 7B) to define an inner boundary of the edge regions 38a, 38b such that the edge regions 38a, 38b remain bonded to the adhesive material 30 after selective removal of the interior region 40 from the adhesive material 30 when applying and bonding the wall 18 to the desired surface of the battery pack 12, as shown in FIG. 8. The opposite edge regions 38a, 38b are spaced from one another by the interior region 40. The opposite edge regions 38a, 38b are shown as extending generally parallel with one another along opposite sides 18a, 18b of the wall 18. The wall 18 is shown as being rectangular, by way of example and without limitation, with opposite ends 18c, 18d not including the filament 26, and thus, remaining substantially open. Accordingly, the filament 26 only extends along one pair of opposite side 18a, 18b. With the ends remaining open, desired thermal activation of the flame resistant coating 20b is facilitated upon a thermal runaway condition. The flame resistant coating 20b, upon being exposed to extreme heat, begins to char, which in turn increases forms a heat barrier, thereby effectively increasing the effectiveness of the flame resistant coating 20b to function as a thermal barrier.

In accordance with another aspect, the scrim layer 28 is not bonded to the ceramic-based layer 22 with an adhesive material. The adhesive material 30 of the pressure-sensitive adhesive layer 24, aside from the adhesive 20d between layers of the flame resistant outer laminate 20, is the only adhesive material in the multilayer wall 18. Accordingly, in addition to reducing cost, less potential fuel is present for flame propagation.

As best shown in FIGS. 7B and 8, the release layer 36 includes a pair of weakened line regions 42 extending between and dividing the interior region 40 and the opposite edge regions 38a, 38b from one another. The weakened line regions 42 are formed inwardly from the stitched filaments 26, such that the stitched filaments 26 extend parallel to and between the weakened line regions 42 and the opposite edges 18a, 18b. The weakened line regions 42 facilitate separation and removal of the interior region 40 from the underlying adhesive material 30 and from the opposite edge regions 38a, 38b while removing the desired intermediate portion of the release layer 36 from the adhesive material 30, thereby leaving the opposite edge regions 38a, 38b fixed to the wall 18 via the filaments 26. The weakened lines regions 42 can be formed via a perforated line, a reduced thickness line (groove), or via being cut, also known as “cracked,” by way of example and without limitation. With the opposite edge regions 38a, 38b remaining in place (FIG. 9A), reinforcement is provided to the filaments 26, which are stitched to fix the flame resistant outer laminate 20, the ceramic-based layer 22, and the pressure-sensitive adhesive layer 24 to one another. Accordingly, the opposite edge regions 38a, 38b assist in preventing the filaments 26 from being pulled through the respective layers 20, 22, 24.

Upon removal of the interior region 40 (FIG. 9A), the insulator 10 can be adhered to the desired surface of the housing 14, such as to a mount bracket (housing member) used to bundle a plurality of cells 16 to form a cell module, or elsewhere, with FIG. 9A illustrates the insulator 10 prior to being assembled to a portion of the housing 14a, and FIGS. 9B and 9C illustrate opposite side views of the insulator 10 after being assembled to a portion of the housing 14a to cover battery cell vents V, through which the battery cells 16 are permitted to breath, with the insulator 10 protected against the emission of hot gas and flame in the event of a thermal runaway condition.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible multilayer thermal insulator for an electric vehicle battery pack, comprising:
a multilayer wall including:
a flame resistant outer laminate;
a ceramic-based layer;
a pressure-sensitive adhesive layer, wherein said ceramic-based layer is sandwiched between said flame resistant outer laminate and said pressure-sensitive adhesive layer; and
at least one filament fixing said flame resistant outer laminate, said ceramic-based layer, and said pressure-sensitive adhesive layer to one another.

2. The flexible multilayer thermal insulator of claim 1, wherein said pressure-sensitive adhesive layer is a single-sided pressure-sensitive adhesive layer including a film layer and an adhesive material on only one side of said film layer, wherein said film layer faces said ceramic-based layer and said adhesive material is spaced from and faces away from said ceramic-based layer.

3. The flexible multilayer thermal insulator of claim 2, wherein said film layer is not bonded to said ceramic-based layer with an adhesive material.

4. The flexible multilayer thermal insulator of claim 2, wherein said pressure-sensitive adhesive layer includes a release layer that is releasably bonded to said adhesive material for removal from said adhesive material to expose said adhesive material for adhesion to a surface of the electric vehicle battery pack.

5. The flexible multilayer thermal insulator of claim 4, wherein said release layer has opposite edge regions spaced from one another by an interior region, said filament passing through said edge regions such that said edge regions remain bonded to said adhesive material after removal of said interior region from said adhesive material.

6. The flexible multilayer thermal insulator of claim 5, further including a weakened line region connecting said interior region to said edge regions, said weakened line region facilitating separation of said interior region from said edge regions while removing said release layer from said adhesive material.

7. The flexible multilayer thermal insulator of claim 2, wherein said outer laminate, said ceramic-based layer, and said pressure-sensitive adhesive layer are not bonded to one another with an adhesive material.

8. The flexible multilayer thermal insulator of claim 7, wherein, other than an adhesive between layers of said outer laminate, said adhesive material of said pressure-sensitive adhesive layer is the only adhesive material in said multilayer wall.

9. The flexible multilayer thermal insulator of claim 1, wherein said flame resistant outer laminate includes an outermost polymeric layer, a flame resistant coating bonded to the outermost polymeric layer, an innermost polymeric layer, a silicone adhesive bonded to the innermost polymeric layer, and a textile fire-resistant layer sandwiched between and bonded to the flame resistant coating and the silicone adhesive.

10. The flexible multilayer thermal insulator of claim 9, wherein said flame resistant coating is a mica and/or silica-based coating.

11. The flexible multilayer thermal insulator of claim 10, wherein said flame resistant coating is a silicone mica coating.

12. The flexible multilayer thermal insulator of claim 1, wherein said ceramic-based layer is a ceramic paper.

13. The flexible multilayer thermal insulator of claim 1, wherein said flexible multilayer wall prevents flame propagation when exposed to temperatures between about 1000-1400° C. for a continuous duration of 5 minutes.

14. The flexible multilayer thermal insulator of claim 1, wherein said flexible composite wall has a maximum thickness of about 2 mm.

15. An electric vehicle battery pack, comprising:
a housing;
a plurality of cells bounded by said housing; and
a flexible multilayer thermal insulator bonded to at least one wall of the housing, the flexible multilayer thermal insulator having a multilayer wall including:
a flame resistant outer laminate;
a ceramic-based layer;
a pressure-sensitive adhesive layer, wherein said ceramic-based layer is sandwiched between said flame resistant outer laminate and said pressure-sensitive adhesive layer; and
at least one filament fixing said flame resistant outer laminate, said ceramic-based layer, and said pressure-sensitive adhesive layer to one another,
wherein the pressure-sensitive adhesive layer is bonded to the at least one wall of the housing.

16. The electric vehicle battery pack of claim 15, wherein said pressure-sensitive adhesive layer is a single-sided pressure-sensitive adhesive layer including a film layer and an adhesive material on only one side of said film layer, wherein said film layer faces said ceramic-based layer and said adhesive material is spaced from and faces away from said ceramic-based layer, and a release layer that is releasably bonded to said adhesive material for removal from said adhesive material to expose said adhesive material for adhesion to the at least one wall of the housing.

17. The electric vehicle battery pack of claim 16, wherein said release layer has opposite edge regions spaced from one another by an interior region, said filament passing through said edge regions such that said edge regions remain bonded to said adhesive material after removal of said interior region from said adhesive material.

18. The electric vehicle battery pack of claim 17, further including a weakened line region connecting said interior region to said edge regions, said weakened line region facilitating separation of said interior region from said edge regions while removing said release layer from said adhesive material.

19. The electric vehicle battery pack of claim 15, wherein the flexible multilayer thermal insulator is bonded between adjacent ones of the cells.

20. The electric vehicle battery pack of claim 15, wherein said flame resistant outer laminate, said ceramic-based layer, and said pressure-sensitive adhesive layer are not bonded to one another with an adhesive material.
